(19) United States
(12) Patent Application Publication
(10) Pub. No.: US 2017/0233241 A1
(43) Pub. Date: Aug. 17, 2017

(54) No Nox

(71) Applicant: Randell J. O' Rielly, Witless Bay, CA (US)

(72) Inventor: Randell J. O' Rielly, Witless Bay, CA (US)

(21) Appl. No.: 15/044,049

(22) Filed: Feb. 15, 2016

(51) Int. Cl. B67D 7/04

(52) U.S. Cl. CPC B67D 7/049; B67D 7/048

(57) ABSTRACT

This invention relates to a system and method of recovering volatile gasoline/petroleum vapours during the supply, handling, and distribution of petroleum products for use in road transport. The system utilizes the vacuum created by a closed shutoff valve outside of a gasoline storage tank, on the vent line, for recovering raw gasoline vapors or fumes while gasoline is being transferred from the gasoline storage tank to a fuel carrying tanker truck, vice-versa, or while gasoline is being transferred from the gasoline storage tank to normal vehicles (cars, pick-up trucks, etc).

### CROSS REFERENCE TO RELATED APPLICATIONS Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to the field of fuel or gasoline handling and transfer systems. The invention particularly relates to a system and method of recovering volatile gasoline/petroleum vapours during the supply, handling, and distribution of petroleum products for use in road transport.

(2) Background of the Invention

The present invention is related to the field of vapor recovery during loading and/or unloading of gasoline between a storage tank and a vehicle, whether it be a car or a fuel carrying tanker truck. The system can further be utilized for fuel transfer between shipping vehicles, railroad cars, airplanes, and marine vehicles.

In practice, during the loading of liquid fuels, such as gasolines and middle distillates, volatile, noxious fumes are displaced, which, in most instances, generally escape into the atmosphere and contribute to overall air pollution in the geographic area. While governments have mandated air quality standards and attempted to remove such contaminants from the air, one of the largest pollution sources is still the transfer of liquid fuels, such as gasolines and other distillates. It has been very difficult to transfer such liquids without the loss of vapors during the transfer process, which results in an increase in the amount of hydrocarbon material in the ambient air. While the prior art contains many attempts to collect such vapors and prevent their loss into the atmosphere, these efforts have not been entirely successful for several reasons.

A number of different types of systems are available for recovering volatile gasoline vapours or fumes. For example, U.S. Pat. Nos. 5,429,159 to Tees et al, U.S. Pat. No. 7,00,4211 to Per, U.S. Pat. No. 6,835,223 to Walker et al, and US Patent Application No. 20040187957 to Scheeter et al.

U.S. Pat. No. 5,429,159 discloses a vacuum-assisted vapor recovery system for trapping and recovering volatile vapors from fuel loading systems during the loading of transport vehicles. The system is designed to maintain an acceptable vacuum and vapor recovery for the multiple filling of multiple vehicles, each possibly having several different shipping compartments. The system has numerous interlocks and safety systems, including pressure valves and pressure controllers to prevent inadvertent or deliberate venting of toxic or noxious vapors into the atmosphere. The invention also includes safety interlocks, which prevent operation of the vehicle loading system without the vapor recovery system being fully connected and completely operational. Various pressure sensors and vacuum limiters are provided to maintain a preferred vacuum range on the vehicle being loaded or unloaded, and interlocks are provided to detect a vacuum leak or any dangerous condition that may arise and thereby shutdown the loading system. The vapors recovered are cycled through a recovery system, such as absorption/adsorption, or may be passed through a flare to burn them off.

Another prior art, U.. Pat. No. 7,004,211, describes a method and device for reducing the evaporation of volatile organic compounds (VOC) when an essentially liquid petroleum product is being filled into a storage and/or transport tank through a drop line, possibly also through a loading point, in which a gas or mixture of gases is supplied to the upper portion of the drop line or the loading point during the filling operation.

One of the disadvantages of conventional vacuum recovery systems is that they tend to be leaky and are not successful in entrapping all of the escaping vapors. Also, many conventional systems for vapor recovery are found to be extremely dangerous because they create explosive mixtures of vapors and air, such as nitrogen oxides (NOx), which are very difficult to handle.

The present invention overcomes these deficiencies by providing a system for recovering vapors within the storage vessel that includes sufficient safety features to prevent vessel collapse, dangerous mixtures of gases, or leaking conditions.

### SUMMARY OF THE INVENTION

In the view of the foregoing disadvantages inherent in the known types of systems for recovering volatile gasoline/petroleum vapours now present in the prior art, the present invention provides an improved system for recovering volatile gasoline/petroleum vapours. As such, the general purpose of the present invention, which will be described subsequently in greater detail, is to provide a new and improved system for recovering volatile gasoline/petroleum vapours that has all of the advantages of the prior art, and none of the disadvantages.

An objective of the invention is to provide a system and method for recovering raw gasoline vapors or fumes when gasoline is being transferred from one vessel to the other.

It is another objective of the present invention to safely displace volatile, noxious fumes between gas tanks, so that ultimately, no vapors escape to the atmosphere.

It is another objective of the present invention to provide a system that works through vacuum pressure when gasoline is being transferred from one vessel to the other.

It is another objective of the present invention to provide a system that removes raw gasoline fumes or vapors from the atmosphere.

It is another objective of the present invention to provide a system that reduces air pollution.

It is another objective of the present invention to provide a system that creates a safe environment when fuel or gasoline is being transferred from one vessel to the other.

It is another objective of the present invention to provide a system that is cost effective.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

The invention will be better understood, and objectives other than those set forth above will become apparent, when consideration is given to the following detailed description thereof. Such description makes reference to the annexed drawings, wherein:

FIG. 1 shows the fuel transfer from an above ground storage tank to a fuel tanker.

FIG. 2 shows the fuel transfer from a fuel tanker to an underground storage tank.

FIG. 3 shows the fuel transfer from a gas station to a vehicle.

### DETAILED DESCRIPTION OF THE INVENTION

In the following detailed description, reference is made to the accompanying drawings, which form a part hereof, and in which is shown, by way of illustration, specific embodiments in which the invention may be practiced. These embodiments are described in sufficient detail to enable those skilled in the art to practice the invention, and it is to be understood that the embodiments may be combined, or that other embodiments may be utilized, and that structural, logical, and electrical changes may be made without departing from the spirit and scope of the present invention. The following detailed description is, therefore, not to be taken in a limiting sense, and the scope of the present invention is defined by the appended claims and their equivalents.

The present invention works by vacuum pressure and is designed to eliminate raw gasoline vapors or fumes from escaping to the atmosphere when liquid is being transferred from one tank to the other. Among the most noxious air pollutants are nitrogen oxides, which are highly reactive gases containing nitrogen and oxygen, collectively known as NOx.

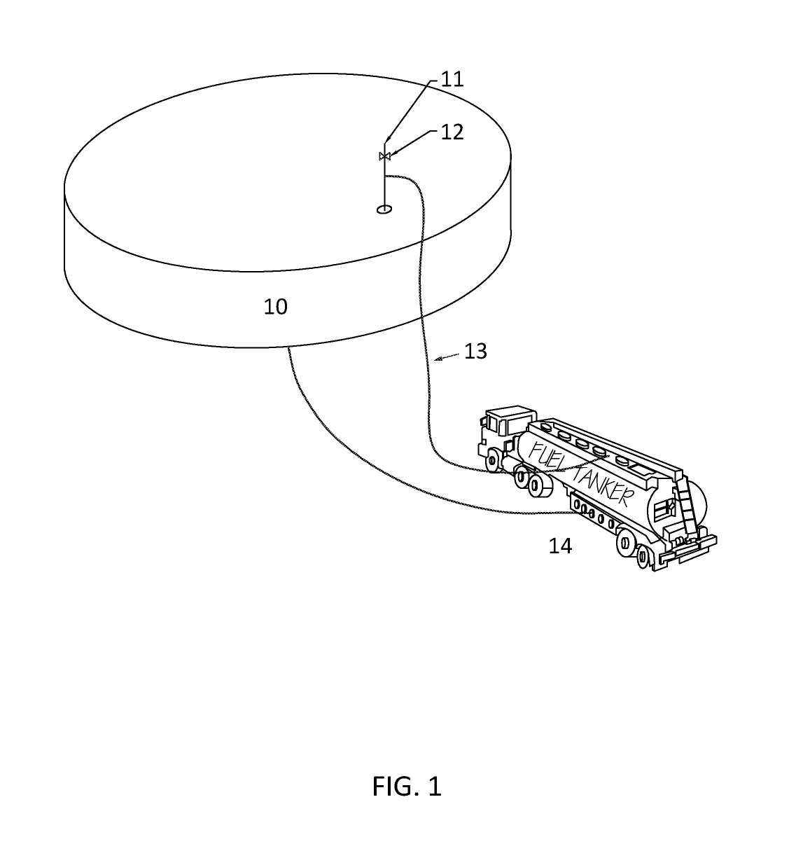

FIG. 1 shows fuel being transferred from an above ground storage tank 10 to a fuel tanker or tanker truck 11. A two-way shutoff valve 12 is installed on the top of the enclosed fuel storage tank 10. Lower, on the same vent pipe 11, a branch pipe (tee) is installed and capped under normal circumstances while there is no transfer of gas. When gasoline starts flowing from storage tank 10 to fuel tanker 11, the cap is removed, and the vent pipe 11 is connected from one tank to the other. The air pollutant NOx travels from the fuel tanker 14 that is being filled to the storage tank 10 that is being emptied, all the while still containing fumes. While filling a tanker truck with fuel, the vapors from the fuel are normally projected into the atmosphere through the vent pipe 11. In the system of the current invention, the shutoff valve 12 that is installed at the top of the vent pipe will be closed, causing a vacuum inside of the storage tank 10. This vacuum and pressure on the tanker truck causes all of the fumes to return to the storage tank 10.

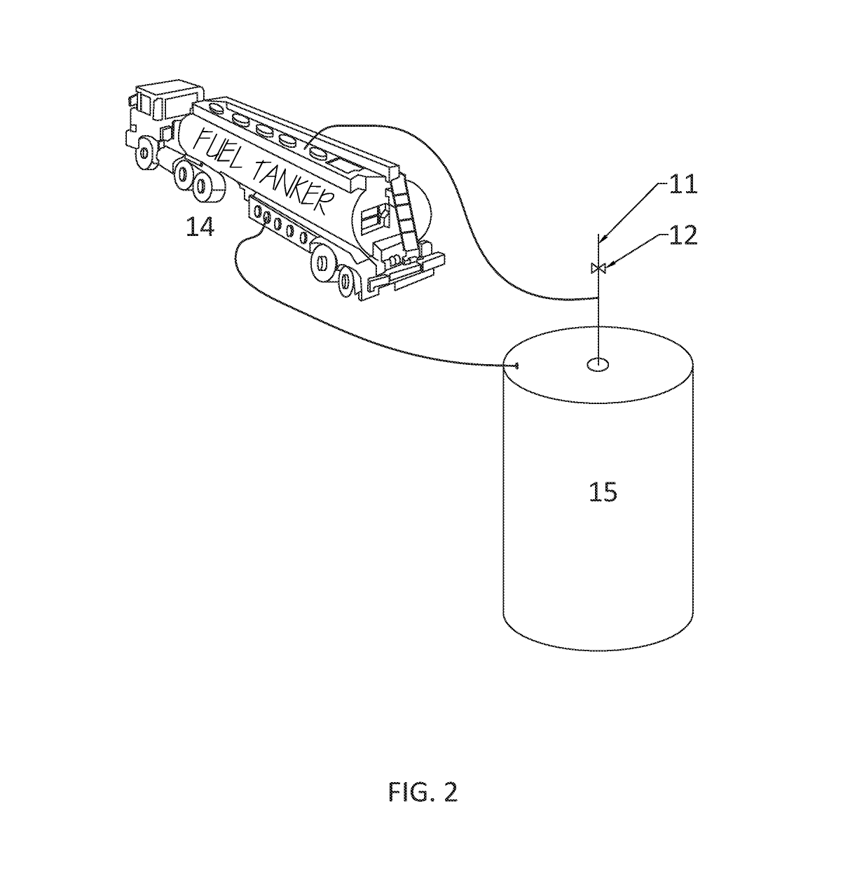

FIG. 2 shows fuel or gasoline being transferred from a fuel tanker 14 to a below ground or underground storage tank 15. Normally, when a fuel tanker or tank truck dispenses fuel to an underground storage tank, pressure is created through the vent pipe 11, creating raw gas fumes to be projected into the atmosphere. In the system of the present invention, the shutoff valve 12 at the top of the vent pipe 11 is kept closed, causing a vacuum inside of the storage tank 15. This vacuum and pressure on the underground storage tank will cause all of the fumes to return to the fuel tanker 14, and ultimately transfer to the storage tank 15.

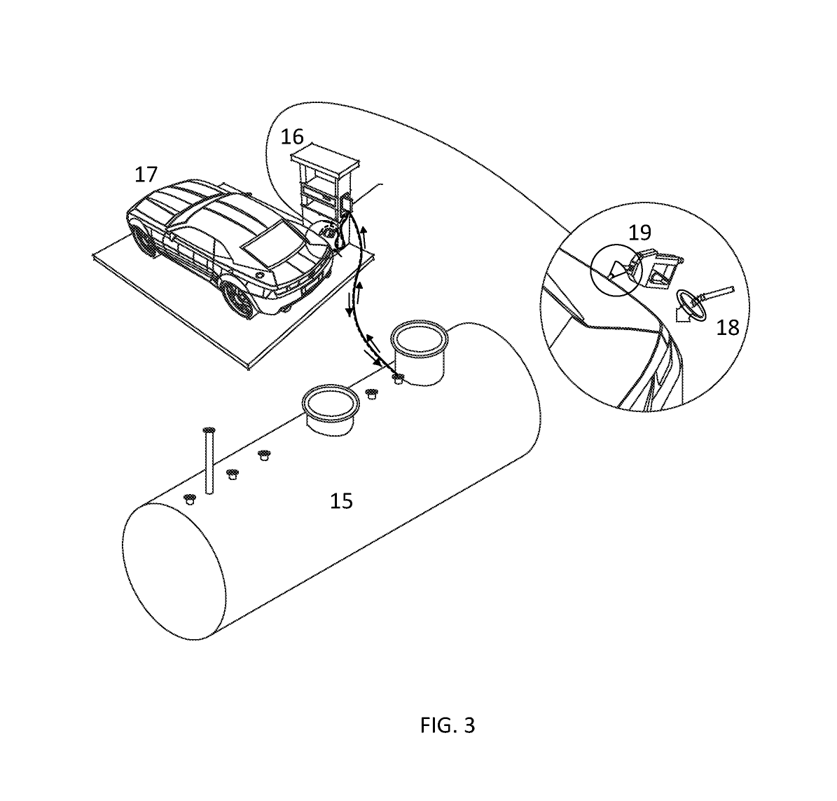

FIG. 3 shows fuel or gasoline being transferred from a gas station (gas pump) 16 to a vehicle (car, pick-up truck, etc.) 17. All that's required at the gas station 16 to incorporate the vapor recovery system, is to replace the existing rubber guard 18 on the gas nozzle, with a rubber cone-shaped guard 19, complete with built-in vent line 11. The cone-shaped guard will seal the vehicle fill pipe, and the noxious vapors inside the vehicle's gas tank (that normally escape into the atmosphere) will be displaced back into the underground storage tank 15 at the gas station, through a new vent line 11. The storage tank 15 is losing fuel, but gaining the same volume of nitrous oxides back. The vehicle 17 is losing fumes, but gaining fuel. A pressure/vacuum release valve 12 will need to be installed as well, to release any unexpected built-up pressure.

The system and method are especially adapted to recover volatile petroleum vapours from delivery tanker vehicles when the tankers discharge or deposit their loads into underground fuel storage tanks at a petrol filling station. The system is also configured so as to recover volatile vapours from individual petrol pumps when being used to dispense petrol into vehicle petrol tanks, thereby mitigating damage to the environment and minimizing exposure of harmful vapours to the individuals dispensing the petrol.

The two-way vacuum/pressure valve has to be set at 1 inch pound per vacuum and 1 PSI of pressure. Such systems can also have applications in other places where gasoline transfer is taking place, such as ships, cars, trucks, etc. All of the parts of the system have to be compatible with gasoline, e.g. rubber that would be used in the valves should be gasoline treated.

In another embodiment, a pressure relief valve may be used in place of a shutoff valve. The pressure relief valve has to be installed on all of the vent pipes. The pressure relief valve can also be set at roughly 1 inch pound per vacuum and 1 PSI of pressure. The increase in pressure beyond 1 PSI may cause damage to the tanks.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

I claim:

1. A system for recovering raw fuel fumes, comprising :
a first unit,
a second unit,
a vent pipe, and
a two way shutoff valve.

2. The system for recovering raw fuel fumes according to claim 1, wherein said raw fuel fumes are gasoline fumes.

3. The system for recovering raw fuel fumes according to claim 1, wherein said first unit is a fuel storage tank.

4. The system for recovering raw fuel fumes according to claim 1, wherein said second unit is a fuel carrying tanker truck.

5. The system for recovering raw fuel fumes according to claim 1, wherein fuel is transferred from said first unit to said second unit using a delivery pipe.

6. The system for recovering raw fuel fumes according to claim 1, wherein said vent pipe is installed on top of said first unit.

7. The system for recovering raw fuel fumes according to claim 6, wherein fuel fumes are normally projected into the atmosphere through said vent pipe.

8. The system for recovering raw fuel fumes according to claim 6, wherein said two-way shutoff valve is installed on top of said vent pipe.

9. The system for recovering raw fuel fumes according to claim 1, wherein said two-way shutoff valve is closed to form a vacuum inside of said first unit.

10. The method of recovering raw fuel fumes, comprising:
providing a first unit and a second unit for fuel transfer,
providing a vent pipe to be installed on top of said first unit,
providing a two way shutoff valve installed on top of said vent pipe.

11. The method of recovering raw fuel fumes according to claim 10, wherein said first unit is a fuel storage tank and said second unit is a fuel carrying tanker truck.

12. The method of recovering raw fuel fumes according to claim 10, wherein said two-way shutoff valve is closed to form a vacuum inside of said first unit.

13. The method of recovering raw fuel fumes according to claim 12, wherein pressure is formed on said second unit due to the closure of said two-way shutoff valve.

14. The method of recovering raw fuel fumes according to claim 13, wherein pressure formed on said second unit causes fumes to return to said first unit.
